(19) United States
(12) Patent Application Publication
(10) Pub. No.: US 2014/0180832 A1
(43) Pub. Date: Jun. 26, 2014

(54) METHODS AND SYSTEMS FOR POPULATING CONTENT ON A WEB PAGE

(71) Applicant: MULU, INC., Rockville, MD (US)

(72) Inventors: Amaryllis FOX, Los Angeles, CA (US); Priyank CHODISETTI, Los Altos, CA (US); Amy COHN, Los Angeles, CA (US)

(21) Appl. No.: 14/192,424

(22) Filed: Feb. 27, 2014

Related U.S. Application Data
(63) Continuation-in-part of application No. 13/706,200, filed on Dec. 5, 2012.
(60) Provisional application No. 61/770,090, filed on Feb. 27, 2013.

(51) Int. Cl. G06Q 30/02

(52) U.S. Cl. CPC G06Q 30/0277; G06Q 30/0275
USPC 705/14.71; 705/14.73

(57) ABSTRACT

Methods and apparatus for automatically placing products on a web page to recommend to individuals may include identifying key attributes in content from at least one web page and assigning one or more products to the key attributes. The methods and apparatus may also include assigning retailers to the one or more products. The methods and apparatus may include selecting at least one product associated with a selected key attribute and providing information on the web page about the selected product to allow a consumer to purchase the product from an associated retailer.

### RELATED APPLICATIONS

This application is a Continuation-in-Part of U.S. application Ser. No. 13/706,200 titled “Methods and Apparatus for Tracking the Purchases of Products,” filed Dec. 5, 2012. This application claims priority to U.S. Application No. 61/770,090 titled “Methods and Systems for Populating Content on a Website,” filed Feb. 27, 2013. U.S. Applications No. 61/770,090 and Ser. No. 13/706,200 are incorporated herein by reference in their entirety.

### BACKGROUND OF THE INVENTION

When consumers purchase products or services online, retailers may provide commissions for referrals. For example, retailers may provide between 2% and 50% of the purchase price of a sale to the web page that referred the consumer. The sales may be tracked by providing an affiliate link to the web page of the retailers. The affiliate links may be provided directly by the retailer and/or through third party affiliate service providers.

Retailers may provide various products on web pages, such as editorial content, blogs, news stories, and/or any other web page where consumers may view the advertised products and/or may elect to purchase the advertised products. However, the products advertised may not be relevant to the content of the web page, and thus, the products may be less likely to be of interest to the consumer viewing the web page.

Thus, there is a need in the art to provide methods and systems for improved product population on web pages.

### SUMMARY

Aspects of the present invention relate to methods and apparatus that, among other things, automatically scan a web page for key attributes, identify products that are relevant to the key attributes, and populate products associated with the key attributes on the web page to recommend to individuals viewing the web page. Aspects of the present invention also relate to methods and apparatus that allow retailers to bid on key attributes that are used on web pages so that the retailer's products populate web pages where the key attributes appear.

Aspects of the present invention also relate to methods and apparatus that allow an individual to collect various items, such as products or services while reading multiple web pages in a central location so that the user may determine at a later time which products or services the individual may want to purchase.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates an example method for automatically placing products on a web page to recommend to individuals in accordance with an aspect of the present invention;

FIG. 2 illustrates an example method for receiving bids for key attributes from retailers in accordance with an aspect of the present invention;

FIG. 3 illustrates an example interface for receiving bids for key attributes in accordance with an aspect of the present invention;

FIG. 4 illustrates an example interface for presenting products that match key attributes in accordance with an aspect of the present invention;

FIGS. 5A-5M illustrate example interfaces for use with aspects of the present invention;

FIG. 6 illustrates various features of an example computer system for use in conjunction with aspects of the present invention; and

FIG. 7 illustrates an example system diagram of various hardware components and other features for use in accordance with aspects of the present invention.

### DETAILED DESCRIPTION

Aspects of the present invention relate to methods and apparatus that, among other things, automatically scan content from a web page for key attributes, identify products that are relevant to the key attributes, and populate products associated with the key attributes on the web page to recommend to individuals viewing the web page and/or allow individuals to purchase the product from an associated retailer. Thus, products presented on the web pages may be more relevant to the content of the web page based upon key attributes appearing in the content on the web page.

Content may include, but is not limited to, editorial text, video, audio, multimedia file, image file, executable, program, web page, script, document, text, data, meta-data music, an electronic representation of a physical item, language, typeface, character set, or any other type of media or information that may be rendered, processed, or executed on a web page.

In an aspect, a company recommending products based upon key attributes that appear in content of the company's web page may earn a commission from the retailer of the product. In addition, a user, such as a blogger may earn a commission by redirecting users to the product page of the retailer for the recommended product presented on the web page of the blogger. For example, the images of the products recommended on a web page may be associated with one or more affiliate links to a respective retailer for the product. The methods and apparatus may track the sales of products using the affiliate links and may ensure that a commission is provided to the user who recommended the product. For example, the commission may be provided to an individual user or a company that selected the recommended product. A server may track and report the purchases earned to the respective retailers.

In another aspect, the company, retailer, and/or users may select to have the commissions donated to one or more non-profit organizations. For example, the user may select a charity and/or other non-profit organizations to receive the commissions earned from referrals. It should be noted that the user may dynamically update the selected charities and/or non-profit organizations. For example, the user may add and/or remove non-profit organizations to the user's selected non-profit organizations who could receive commission revenue. In addition, a user may select the percentage of revenue going to each non-profit organization. For example, the user may select to have each non-profit organization receive an equal amount of commission revenue or may allocate a percentage of the revenue to each non-profit organization. In addition, the user may identify revenues from sales of a particular product to be allocated to a non-profit organization, while revenues from sales of a different product may be allocated to a different non-profit organization. Moreover, the user may select to split the received commission revenue between the user and various non-profit organizations. Upon receiving commission revenues from retailers, a server may distribute the commission revenue accordingly to each of the selected non-profit organizations.

Aspects of the present invention also relate to methods and apparatus that allow retailers to bid on key attributes of web pages, such as keywords, so that the retailer's products are populated on web pages where the keywords appear. For example, if a blog is discussing new shoes, retailers may bid on a keyword “shoes” to have shoes sold by the retailer appear in the blog. Thus, retailers may have more targeted advertising of the products based upon key attributes that appear in the content of web pages.

Aspects of the present invention also relate to methods and apparatus that allow an individual to collect various items, such as products or services, while reading multiple web pages in a central location so that the user may determine at a later time which products or services the individual may want to purchase. As such, as an individual reads multiple web pages, the individual may have the ability to collect a plurality of products the individual may want to purchase and be directed to the appropriate retailer's web page at a later time.

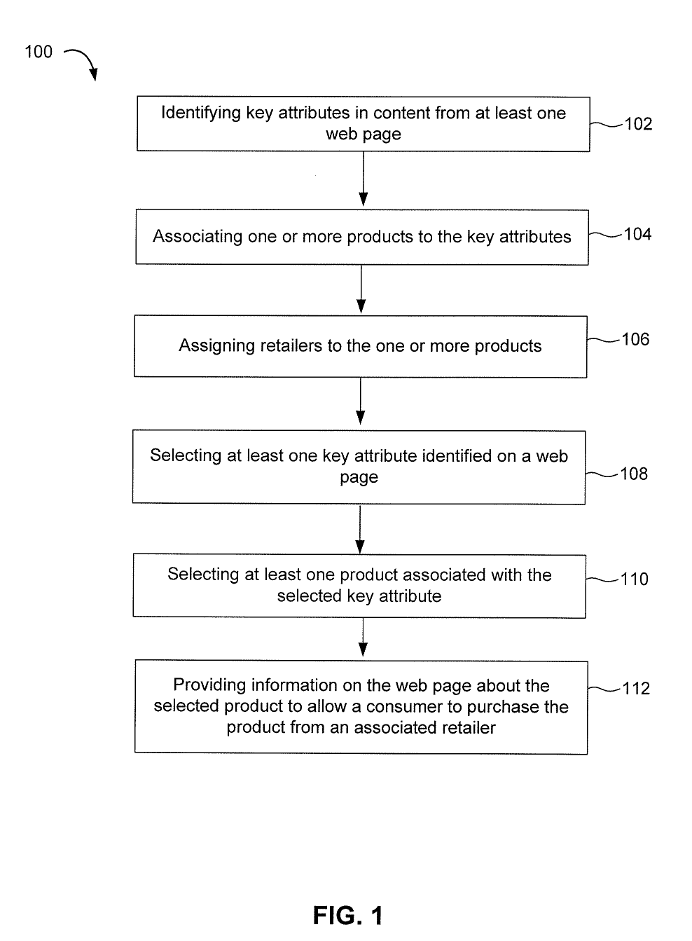

Referring now to FIG. 1, therein illustrated is an example method flow 100 for automatically placing products on a web page in accordance with an aspect. The method may include identifying key attributes in content from at least one web page 102. Key attributes may include, but are not limited to, keywords (e.g., a word or set of words), images, and sounds. For example, content from a plurality of web pages may be retrieved and may be analyzed for key attributes. In an aspect, each word mentioned in the text may be classified as a keyword. In another aspect, a user may review the content from the web pages and may create hierarchical trees with words selected from the content. The keywords may be selected from the hierarchical trees created by the users. In one example, the words at the end of the tree may be considered keywords.

In another aspect, a server may receive content of a web page from a variety of inputs and may identify key attributes in the content. For example, a crawler may scan web pages, such as blogs, on-line articles, news articles, and/or other on-line content and may automatically retrieve the text from various web pages and provide the retrieved text to the server. The server may perform a variety of processing on the retrieved text to identify key attributes from the text. Processing may include, but is not limited to, extracting information from the text (e.g., products and/or services mentioned in the text), extracting information from video (e.g., products and/or services mentioned in images, text, and/or audio from the video), removing common words (e.g., stop words, such as “a”, “the”, “to”, etc.), determining a frequency of words, determining an importance of words, and combing words into phrases, among other processing. In addition, the server may populate a key attribute data repository with the identified key attributes. For example, the key attribute data repository may include a database with keywords and/or images that are typically used on a plurality of web pages.

The method may also include associating one or more products to the key attributes 104. In an aspect, the server may retrieve product information and use a variety of processing to associate one or more products to the identified key attributes. Product information may be provided to the server, for example, from product data repositories, retailers, web pages, user input, etc. A company selecting the products for presentation on the web page may have a relationship with a retailer and may assign products from the retailer to identified key attributes. For example, the company may have a relationship with Williams Sonoma, and thus, the server may assign a key attribute “whisk” to a whisk sold by Williams Sonoma. In another example, a user may select products based upon how the products look (e.g., select products that are appealing to the eye, based upon color, etc.). It should be noted that the server may have a product database for various retailers and may associate the products for each retailer with various key attributes.

In addition, the method may include assigning retailers to the one or more products 106. In an aspect, the server may assign universal resource locator (URL)s of retailers to the one or more products. For example, the server may access the product database for the various retailers and assign a URL link to the product page for the products associated with the various retailers. In another aspect, the server may access a dataset of retailer names associated with products and assign a retailer name to the one or more products.

The method may further include selecting at least one key attribute identified on a web page 108. In an aspect, the server may receive the text of a web page and may match the words from the text to keywords retrieved from the key attribute database. A crawler or other data retrieval system may retrieve the text from various web pages and the server may compare the retrieved text with the keywords in the key attribute database. For example, the web page may have 10 words that match keywords from the key attribute database. In another aspect, a crawler or other data retrieval system may retrieve video from various web pages and the server may compare images, audio, and/or text from the retrieved video with the key attributes database. For example, the web page may have two images that match key attributes. In an aspect, a crawler or other data retrieval system may retrieve audio from various web pages and the server may compare the retrieved audio with the key attributes database. As such, the server may select at least one key attribute identified on the web page from the key attributes database identified in the content of the web page.

The method may also include selecting at least one product associated with the selected key attribute 110. In an aspect, when a match occurs between the key attribute and the content retrieved from the web page, the server may retrieve a product from the product databases that is assigned to the key attribute. For example, if the key attribute is a keyword “grapefruit,” the server may retrieve a set of grapefruit spoons from the product database that are assigned to the key attribute “grapefruit.” In another example, the key attribute may be an image of a mixer and the server may retrieve a variety of mixers from the product database. In an aspect, the server may apply a ranking to the products when selecting a product associated with the key attribute. The products may be ranked, for example, based upon brand names, attributes, price, amount of money a company may earn from a commission, appearance, color, size, etc. Thus, products with a higher ranking relative to other products may be selected first by the server for recommendation on the web page as compared to products with a lower ranking.

The method may additionally include providing information on the web page about the product selected to allow a consumer to purchase the product from an associated retailer 112. In an aspect, the server may provide product information for a plurality of products on the web page associated with the selected key attributes. For example, if the key attribute is a keyword “beauty”, the server may provide information about twelve different beauty products on the web page. In addition, the server may provide product information for a plurality of key attributes identified in the content of the web page. For example, if a video on the web page includes a key attribute “dresses” and the editorial text on the web page includes a key attribute “watch,” the server may provide product information associated with dresses and watches.

In an aspect, the server may provide product information on a plurality of web pages for key attribute(s) identified in the plurality of web pages. One example may include a set of web pages from a publisher discussing mascaras. The server may process the content received from the web pages and may identify mascara as a key attribute mentioned in the content of the web pages. The server may also identify that one web page from the set of web pages references a specific brand name of mascara. The server may, for example, select a mascara associated with the brand name from the product database and transmit product information for the selected mascara to all, or a portion, of the set of web pages from the publisher. In addition, the server may, for example, transmit product information about additional mascaras to all or a portion of the set of web pages from the publisher. The server may select the additional mascaras based upon, for example, brand name, price, and color. Thus, the server may examine the content multiple web pages and identify key attributes and products mentioned in the content. In addition, the server may provide product information on a plurality of web pages based upon key attributes and/or products identified in the plurality of web pages.

In an aspect, the server may transmit an image of the selected product(s) to present on the web page to allow a consumer to purchase the selected product from an associated retailer. For example, the image may include a URL link to a product database of the retailer associated with the selected product. In an aspect, the server may add images of the selected products on the web pages. For example, the server may have images of the products stored in the product databases. The images may include a URL link to the retailer associated with the selected products. The server may insert the images of the products into the web page and the server may enable the delivery of the product images to the web page for presentation. Upon clicking on the image, the URL link associated with the selected images may be used to link to the product pages for the products represented in the selected images. As such, an individual may be able to select an image of the product on the web page and be directed to the product page of the retailer associated so that the individual may purchase the selected product.

In another aspect, the server may receive a selection of images from an individual and store the selected images, for example, in a shopping cart associated with the individual. An individual may collect images of various products in a central location so that the user may determine at a later time which products the individual may want to purchase. For example, an individual may drag and drop the images of products into a shopping cart. As an individual reads multiple web pages, the individual may have the ability to collect a plurality of products the individual may want to purchase and be directed to the appropriate retailer's web page at a later time. The server may facilitate the purchase of a product. For example, the server may direct the individual to a shopping portal to place an order for selected products. In another example, the individual may select the image of the product and the URL link associated with the selected images may be used to link to the product pages for the retailer of the selected images.

In an aspect, the URL may include an affiliate link to the retailer associated with the selected product. The affiliate link may be used to track the purchases made through the affiliate links so that referral commissions may be captured more easily. The server may periodically report the purchase information to each retailer associated with the affiliate links. For example, the server may report the purchase information to the retailers on a quarterly basis. In an aspect, the company and/or the retailer may determine whether a percentage of the commission earned from the sales of products purchased through recommendations from the content provider web page may be donated to a charity or other non-profit organization.

In an optional aspect, the method may further include receiving images of products from individuals viewing the web page. For example, the server may receive images selected by individuals of favorite products and the server may add the received images of favorite products to the recommended products presented on the web page. Thus, the method may allow product recommendations through various crowd sourcing techniques.

In another optional aspect, the method may include facilitating sharing products with other individuals. For example, the server may receive a selection of images of products from an individual to share with other individuals. The server may transmit images of the selected products to other individuals using, for example, an e-mail message, a social media message, a social media account, a short message service (SMS) message, a multimedia messaging service (MMS) message, and AirDrop.

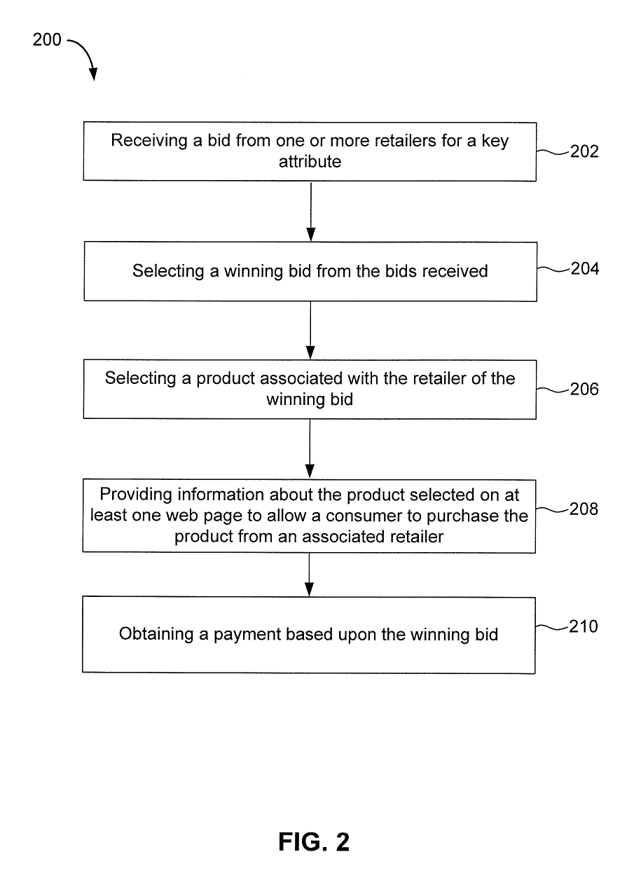

Referring now to FIG. 2, therein illustrated is an example method flow 200 for receiving bids for key attributes from retailers in accordance with an aspect. For example, a company may solicit bids for key attributes to populate advertisements and/or other areas of web pages with the products of the retailer that wins the bidding process. The method may include receiving a bid from one or more retailers for a key attribute 202. The bid may be for a key attribute on a specific web page, a group of web pages (e.g., fashion web pages), across the entire network, or may identify specific web pages to not present the products on (e.g., do not show on news articles). In addition, the bid may be for a single product or a plurality of products to display in connection with the key attribute. The bid may also include a bid amount for the key attribute. The bid amount may be a range of values, e.g., a minimum price to a maximum price the retailer is willing to pay for the key attribute, or a specific amount the retailer is willing to pay for the key attribute, among others. In addition, the bid may have a default price (e.g., a minimum bid the retailer must submit for the key attribute). In an aspect, a server may generate an interface to receive bids from one or more retailers for key attributes and transmit the interface for presentation on a device, such as a computer, wireless device, tablet, cellular telephone, etc.

The method may also include selecting a winning bid from the bids received 204. In an aspect, a server may apply one or more rules in determining which bid is the winning bid. Rules for determining a winning bid may include, but are not limited to, a maximum amount bid for the key attribute, a retailer who generates more traffic (e.g., more individuals view and/or purchase the products of the retailer), content site requirements, business requirements, and a retailer that pays the company a higher commission for referring products to the retailer, among other ways to determine a winning bid. For example, a retailer may have bid the highest dollar amount for a key attribute but may not be selected as the winning bid if the web page does not allow the retailer to advertise on the web page. It should be noted that more than one winning bid may be selected. For example, a lower bid may be selected for presentation further down in the product list. Thus, a product for the retailer who had the highest bid may be presented first, while a product for another retailer with a lower bid may be presented a the end of the product list.

In addition, the method may include selecting a product associated with the retailer of the winning bid 206. For example, the server may access a product database and retrieve one or more products associated with the retailer of the winning bid, as discussed in more detail in FIG. 1.

The method may further include providing information about the product selected on at least one web page to allow a consumer to purchase the product from an associated retailer 208. For example, the server may present an image of the selected product on the web page, as discussed in more detail in FIG. 1. In an aspect, the server may present images of products from multiple bids. Thus, a product for the retailer who had the highest bid may be presented first, while a product for another retailer with a lower bid may be presented a the end of the product list. In another aspect, the server may present images of products from winning bids and the images of products selected with the key attributes process described in FIG. 1. Images of products from retailers with bids may be presented, for example, higher in a product list, while images of products selected using key attributes of the content may be presented lower in the product list. For example, if the company wanted to present ten products on a web page, the server may present images of eight products associated with the winning bids first and images of two products selected based upon key attributes from the content of the web page at the end of the product list.

The method may also include obtaining a payment based upon the winning bid 210. For example, the server may receive a payment directly from the retailer for the winning bid. In addition, the server may receive a payment from a third party for the winning bid. It should be noted that a variety of payment structures may be used to generate the payment for the winning bid. For example, the methods and apparatus may track the number of impressions (e.g., views and/or page clicks) of the images in the recommended products and may generate a commission based upon the number of impressions. In an aspect, a retailer may agree to pay the company a cost per mille (CPM) commission based on the number of views of images in the recommended products (e.g., $20 per thousand image views). In another aspect, the retailer may agree to pay the company a payment per click (PPC) commission based on the number of page clicks of items from the recommended content.

In an aspect, the company and/or the retailer may determine whether a percentage of the commission earned from the sales of products purchased through recommendations from the content provider web page may be donated to a charity or other non-profit organization.

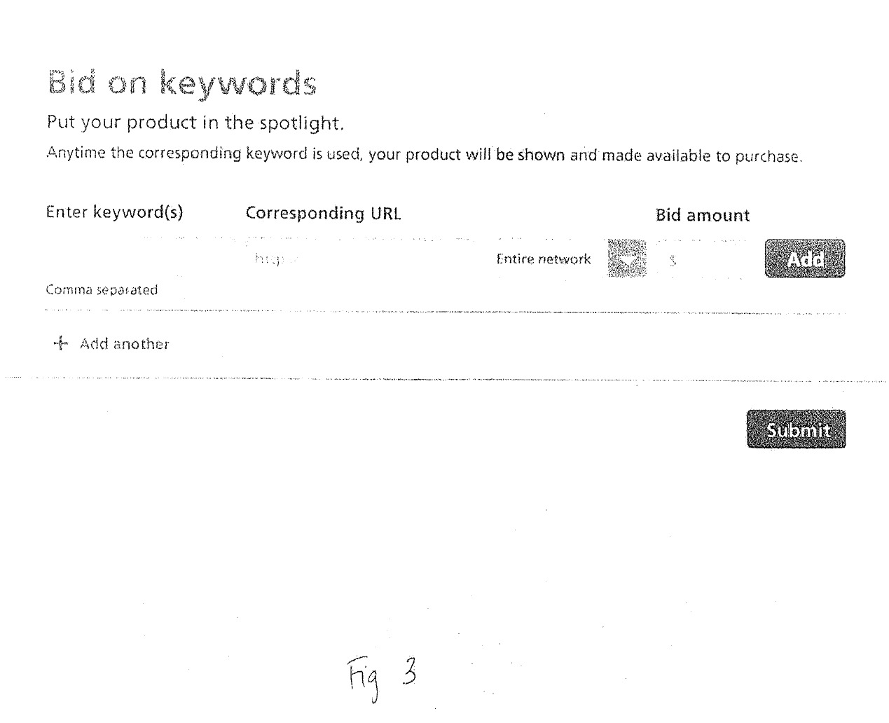

Referring now to FIG. 3, illustrated therein is an example interface for receiving bids for keywords in accordance with an aspect.

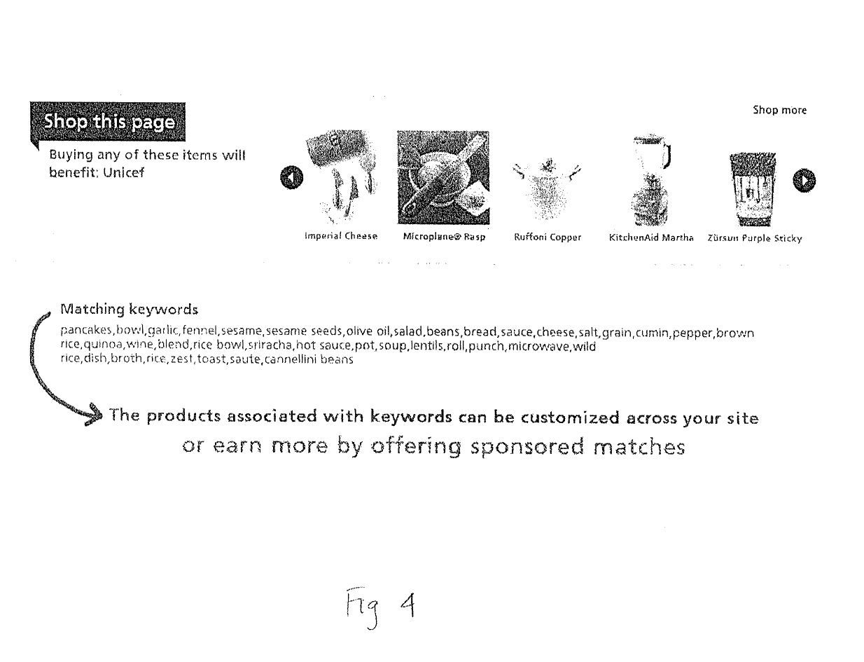

Referring now to FIG. 4, illustrated therein is an example interface for presenting products that match keywords in accordance with an aspect.

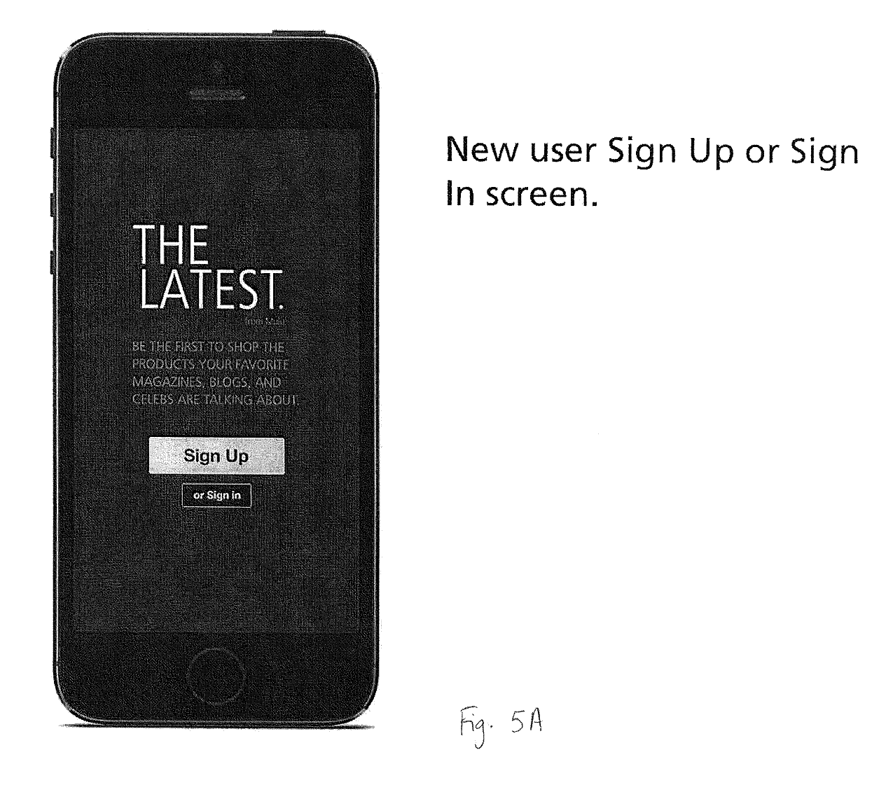

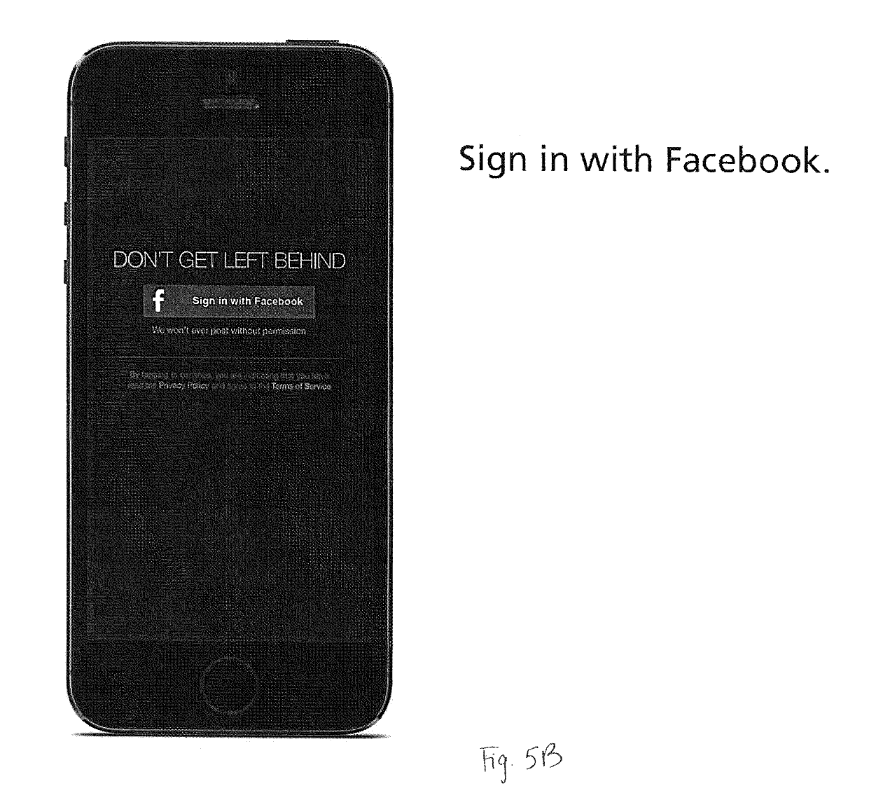

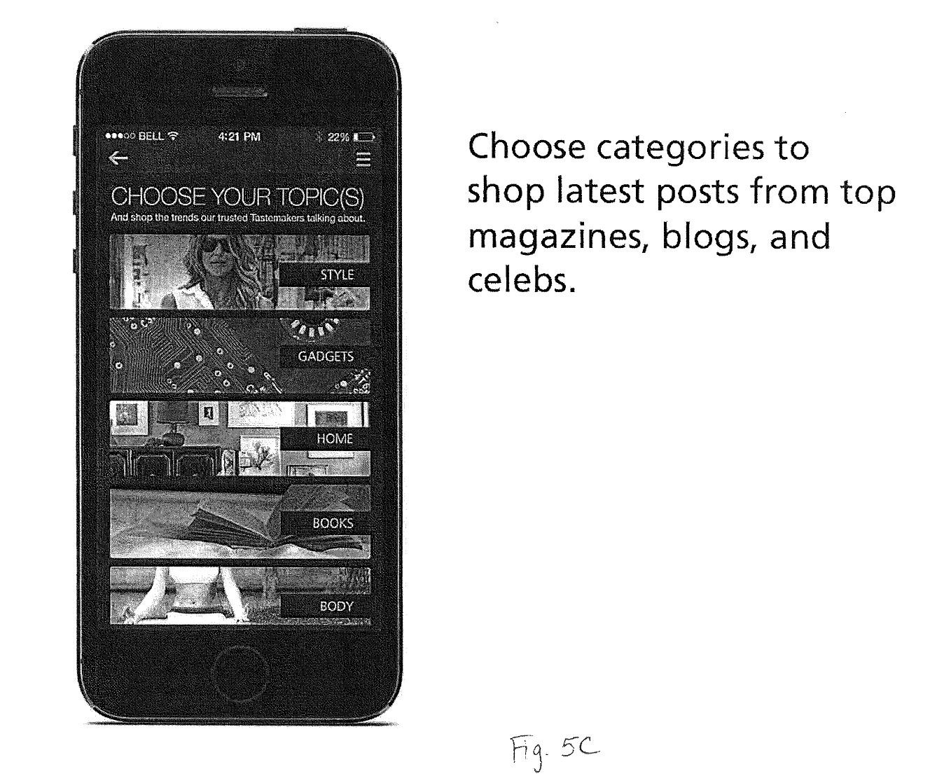

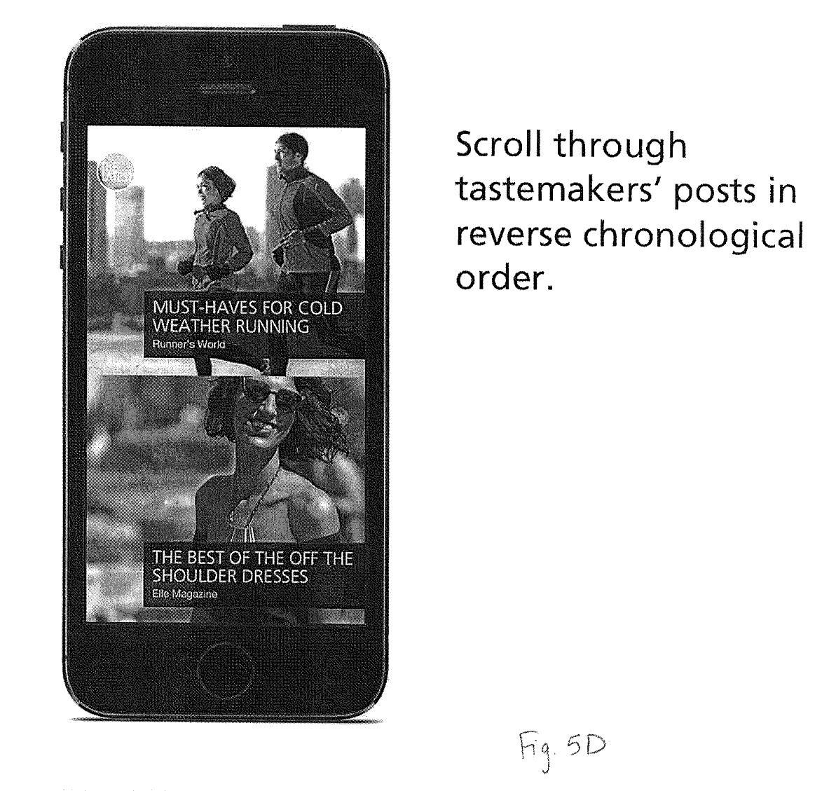

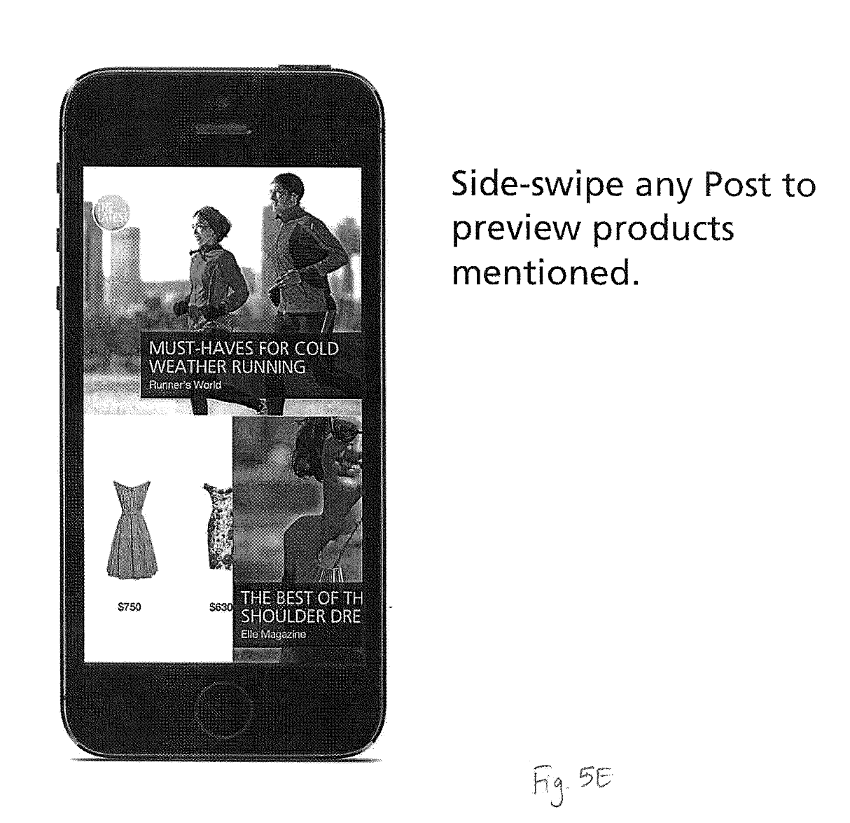

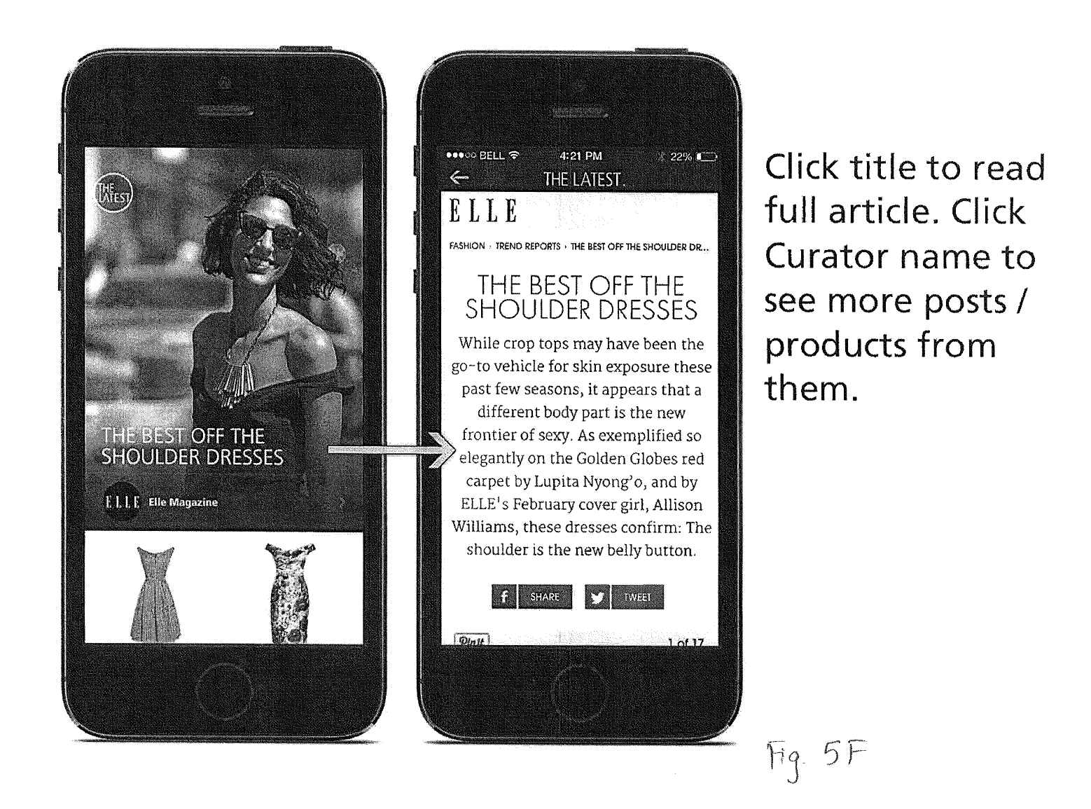

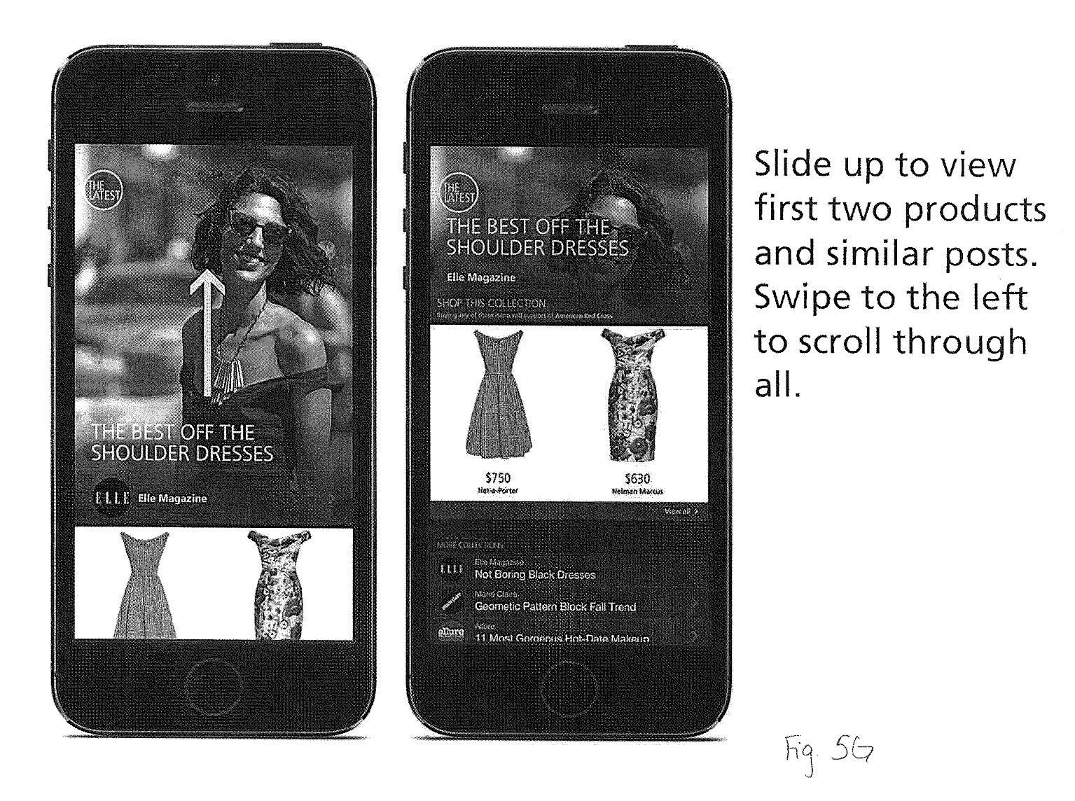

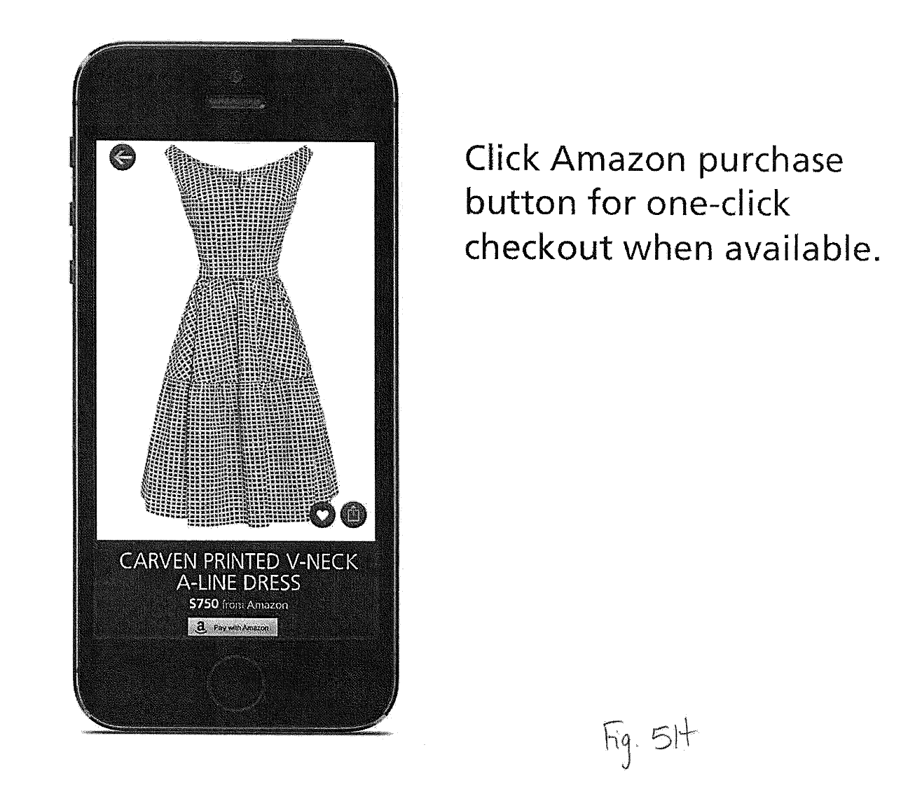

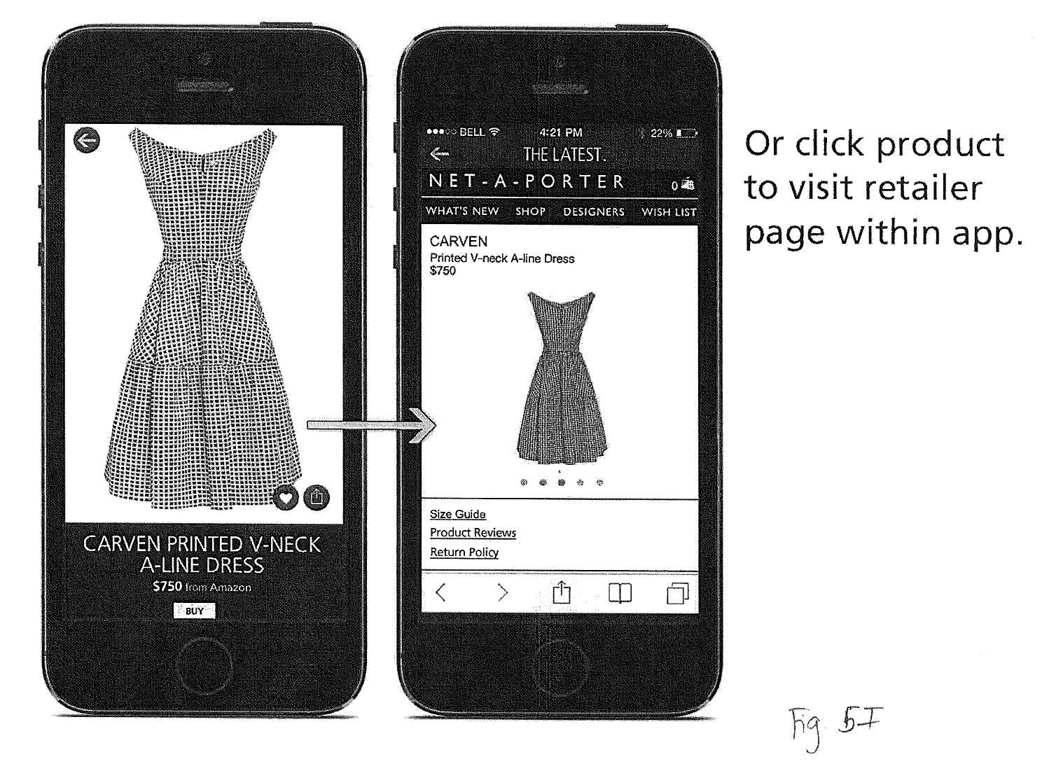

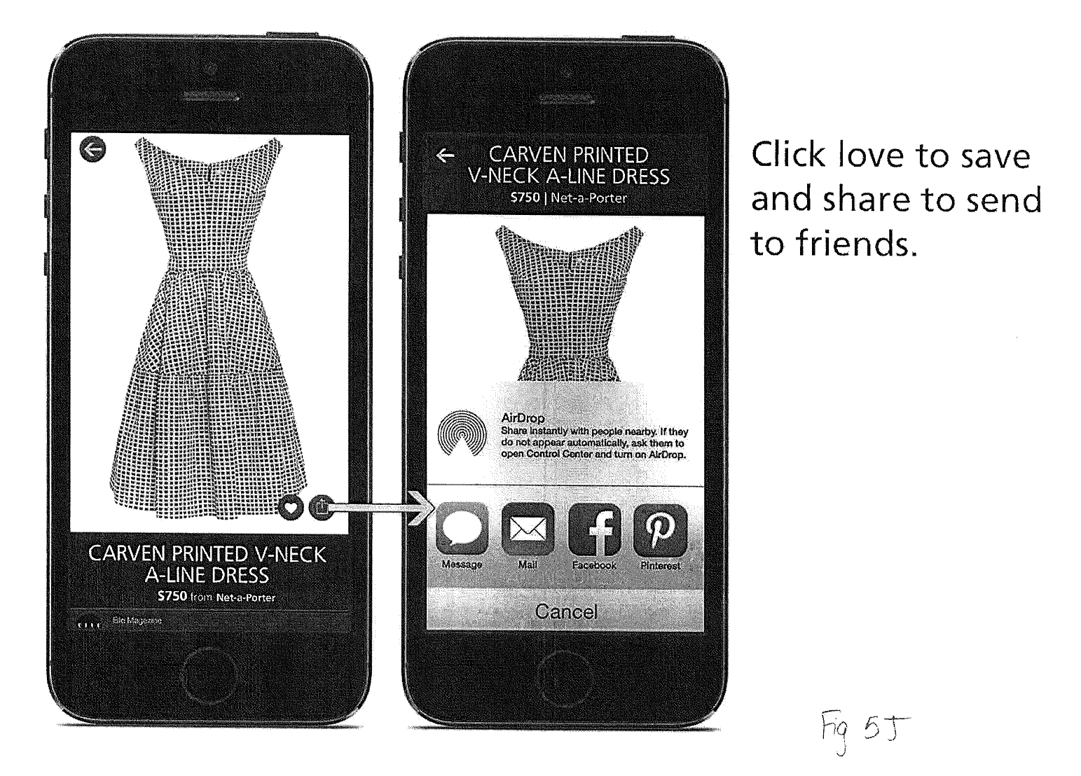

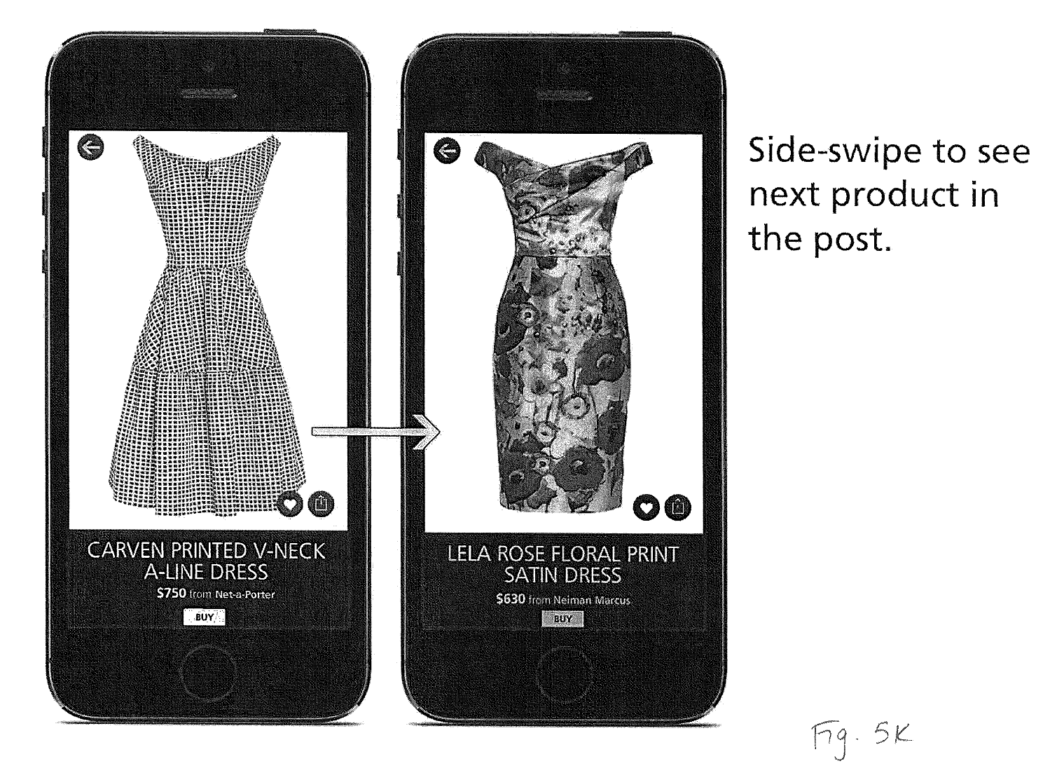

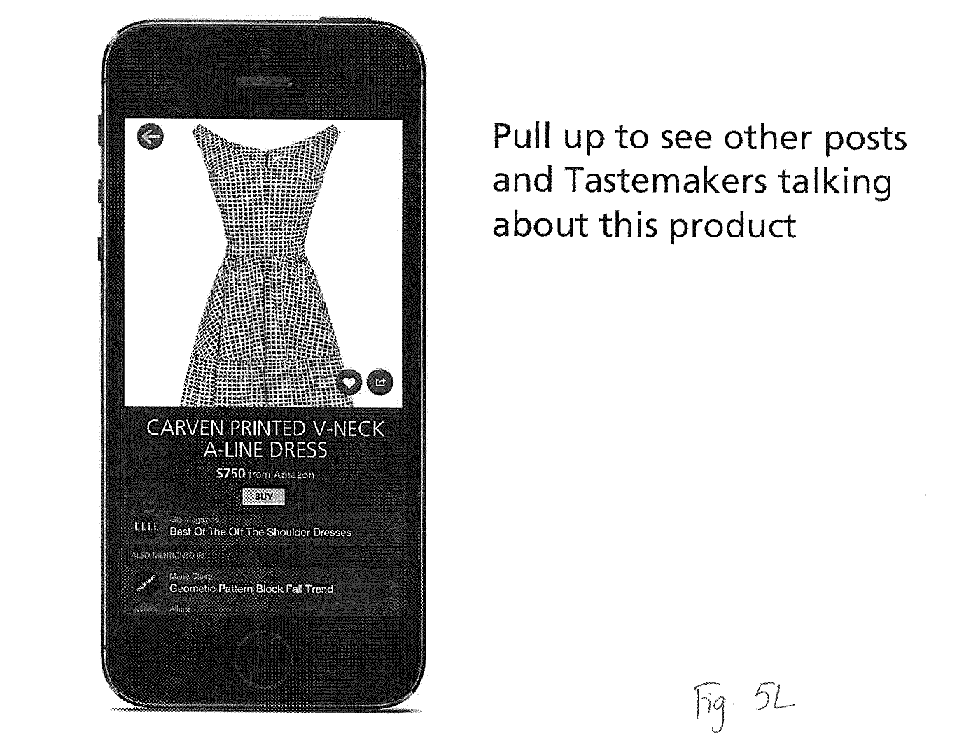

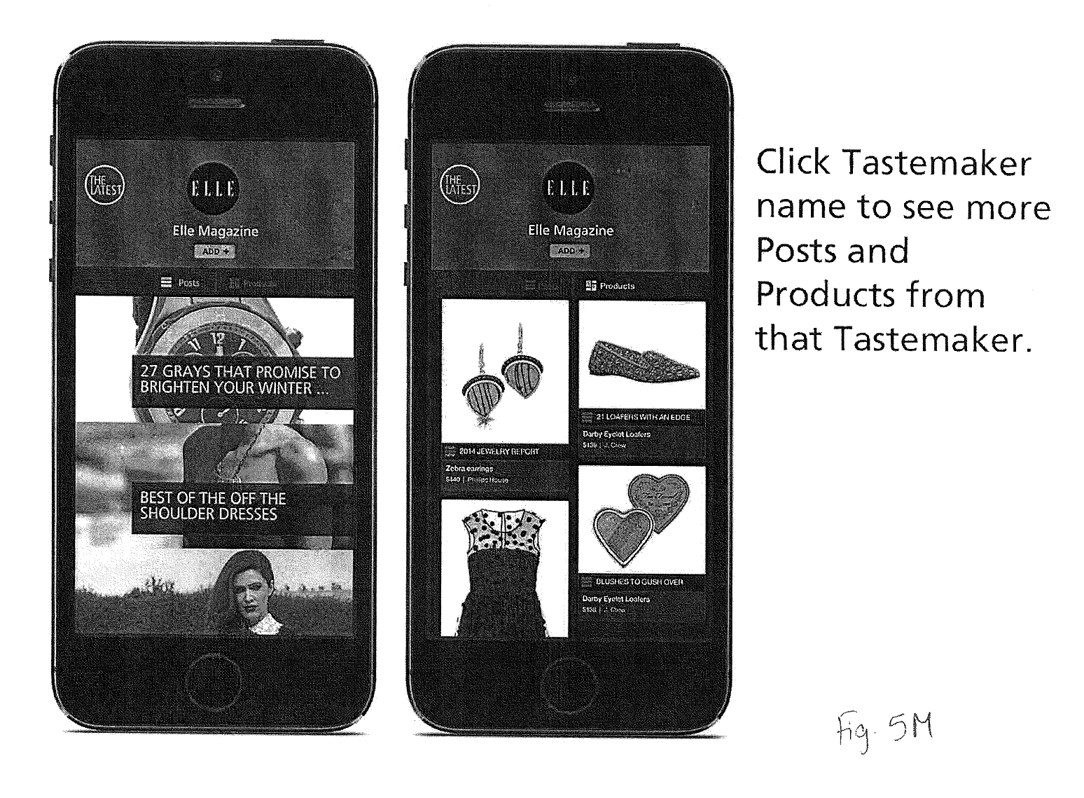

Referring now to FIGS. 5A-5M, illustrated therein are example graphical user interfaces (GUI) screens illustrating exemplary implementations of aspects of the present invention using a wireless device. A wireless device may include any mobile or portable computing or communications device, such as a cellular device, that may connect to an access network. Wireless devices may be, for example, a cellular telephone, a navigation system, a computing device, a camera, a PDA, a music device, a gaming device or a handheld device having wireless connection capability, among other devices. For example, FIGS. 5A and 5B illustrate a registration process for a mobile application. The registration process may include, for example, providing access to one or more social media accounts, such as Facebook™ or Twitter™, and/or providing permission for the application to access data used by the one or more social media accounts.

FIG. 5C illustrates, for example, an initial data collection process performed by the application. A user may be presented with a list of categories a user may select to shop from and/or follow trends. Categories may include, but are not limited to, style, beauty, gadgets, sports, home, food, books, body, cars, art, music, videos, baby, and toys. In an aspect, the categories may be populated with images of products using the processing described in FIGS. 1 and 2. In another aspect, tastemakers (e.g., individuals selected to curate the categories) may populate the categories with, for example, product information, articles, and videos.

FIGS. 5D-5G, for example, illustrate category information that may be presented to a user. FIG. 5D illustrates an example where a user may scroll through information presented in a category, such as a post by a tastemaker, in reverse chronological order. In addition, FIG. 5E illustrates an example where a user may side-swipe the post to preview products mentioned in the post. FIG. 5F illustrates an example where a user selects to read a full article linked to the post. FIG. 5G illustrates an example of viewing products associated with key attributes from the post and a listing of similar posts a user may be interested in viewing.

FIGS. 5H and FIG. 1 illustrate example purchasing options a user may have when using the application. For example, a user may use a third party service to purchase a product, as illustrated in FIG. 5H. Another example may include linking the user to the retailer's product page, as illustrated in FIG. 5I.

In addition, a user may share products with other individuals using the application, as illustrated in FIG. 5J. In addition, a user may view other posts by a selected tastemaker and/or posts by other tastemakers, as illustrated in FIGS. 5K-5M.

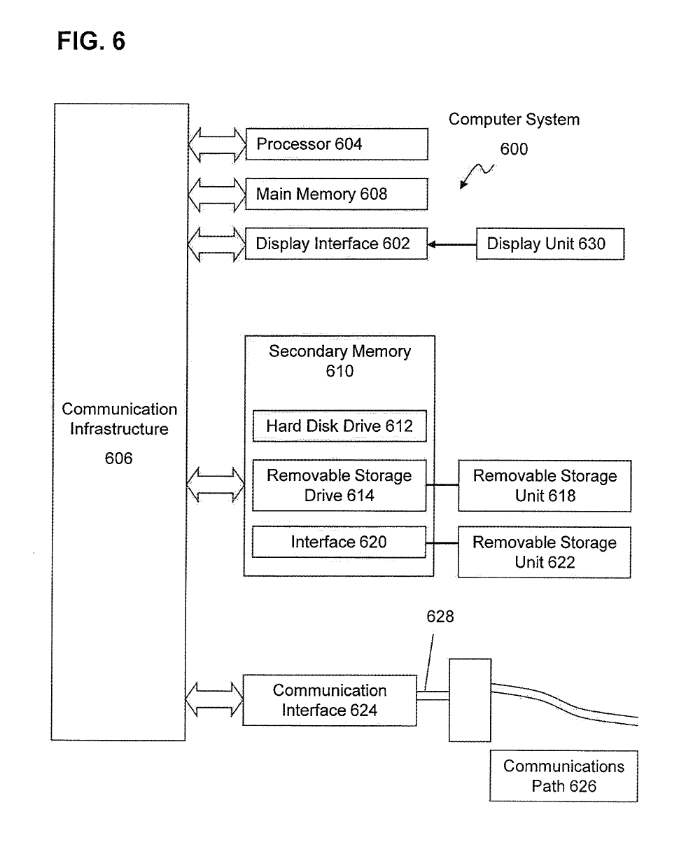

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 600 is shown in FIG. 6.

Computer system 600 includes one or more processors, such as processor 604. The processor 604 is connected to a communication infrastructure 606 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 600 can include a display interface 602 that forwards graphics, text, and other data from the communication infrastructure 606 (or from a frame buffer not shown) for display on a display unit 630. Computer system 600 also includes a main memory 608, preferably random access memory (RAM), and may also include a secondary memory 610. The secondary memory 610 may include, for example, a hard disk drive 612 and/or a removable storage drive 614, representing a floppy disk drive, a magnetic tape drive, an optical disk drive, a universal serial bus (USB) flash drive, etc. The removable storage drive 614 reads from and/or writes to a removable storage unit 618 in a well-known manner. Removable storage unit 618 represents a floppy disk, magnetic tape, optical disk, USB flash drive etc., which is read by and written to removable storage drive 614. As will be appreciated, the removable storage unit 618 includes a computer usable storage medium having stored therein computer software and/or data.

Alternative aspects of the present invention may include secondary memory 610 and may include other similar devices for allowing computer programs or other instructions to be loaded into computer system 600. Such devices may include, for example, a removable storage unit 622 and an interface 620. Examples of such may include a program cartridge and cartridge interface (such as that found in video game devices), a removable memory chip (such as an erasable programmable read only memory (EPROM), or programmable read only memory (PROM)) and associated socket, and other removable storage units 622 and interfaces 620, which allow software and data to be transferred from the removable storage unit 622 to computer system 600.

Computer system 600 may also include a communications interface 624. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. Software and data transferred via communications interface 624 are in the form of signals 628, which may be electronic, electromagnetic, optical or other signals capable of being received by communications interface 624. These signals 628 are provided to communications interface 624 via a communications path (e.g., channel) 626. This path 626 carries signals 628 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 680, a hard disk installed in hard disk drive 670, and signals 628. These computer program products provide software to the computer system 600. The invention is directed to such computer program products.

Computer programs (also referred to as computer control logic) are stored in main memory 608 and/or secondary memory 610. Computer programs may also be received via communications interface 624. Such computer programs, when executed, enable the computer system 600 to perform the features in accordance with aspects of the present invention, as discussed herein. In particular, the computer programs, when executed, enable the processor 604 to perform the features in accordance with aspects of the present invention. Accordingly, such computer programs represent controllers of the computer system 600.

In an aspect of the present invention where the invention is implemented using software, the software may be stored in a computer program product and loaded into computer system 600 using removable storage drive 614, hard drive 612, or communications interface 620. The control logic (software), when executed by the processor 604, causes the processor 604 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, the invention is implemented using a combination of both hardware and software.

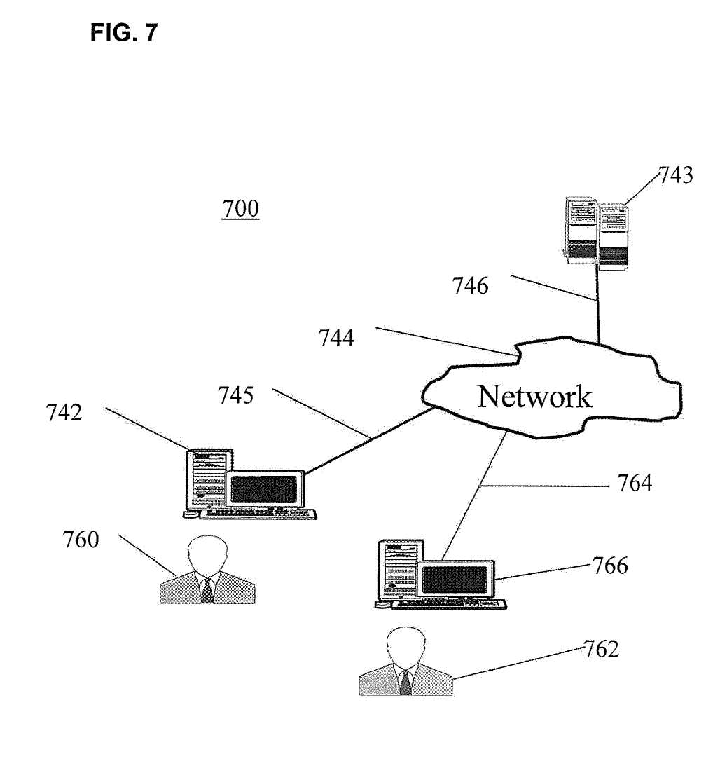

FIG. 7 shows a communication system 700 usable in accordance with aspects of the present invention. The communication system 700 includes one or more accessors 760, 762 (also referred to interchangeably herein as one or more “users”) and one or more terminals 742, 766. In one aspect of the present invention, data for use is, for example, input and/or accessed by accessors 760, 764 via terminals 742, 766, such as personal computers (PCs), minicomputers, mainframe computers, microcomputers, telephonic devices, or wireless devices, such as personal digital assistants (“PDAs”) or a hand-held wireless devices coupled to a server 743, such as a PC, minicomputer, mainframe computer, microcomputer, or other device having a processor and a repository for data and/or connection to a repository for data, via, for example, a network 744, such as the Internet or an intranet, and couplings 745, 746, 764. The couplings 745, 746, 764 include, for example, wired, wireless, or fiberoptic links. In another aspect of the present invention, the method and system of the present invention operate in a stand-alone environment, such as on a single terminal.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

1. A method for automatically placing products on a web page to recommend to individuals, the method comprising:
identifying key attributes in content from at least one web page;
assigning one or more products to the key attributes;
assigning one or more universal resource locators (URLs) of retailers to the one or more products;
selecting at least one key attribute identified on the web page;
selecting at least one product associated with the key attribute identified on the web page; and
presenting an image of the selected product on the website to allow a consumer to purchase the selected product from an associated retailer, where the image includes a URL link to a product page of the associated retailer.

2. The method of claim 1, wherein selecting the at least one product further comprises:
receiving a bid from one or more retailers for the key attribute;
selecting a winning bid from the received bids; and
selecting a product associated with the retailer of the winning bid.

3. The method of claim 1, wherein identifying key attributes in the content further comprises one or more of extracting text from the content of the web page, removing common words from the text, determining a frequency of words, determining an importance of words, and combing words into keywords.

4. The method of claim 1, wherein identifying key attributes in the content further comprises:
extracting information from video on the web page.

5. The method of claim 1, further comprising:
receiving a selection of a plurality of images; and
storing the plurality of images in a shopping cart.

6. The method of claim 1, wherein transmitting the image of the selected product further comprises:
transmitting the image of the selected product to a mobile application on a wireless device.

7. The method of claim 1, further comprising:
sharing, via a message, the image of the selected product with other individuals.

8. An apparatus for automatically placing products on a web page to recommend to individuals, the apparatus comprising:
a memory in communication with a processor
wherein the processor is configured to:
identify key attributes in content from at least one web page;
assign one or more products to the key attributes;
assign one or more universal resource locators (URLs) of retailers to the one or more products;
select at least one key attribute identified on the web page;
select at least one product associated with the key attribute identified on the web page; and
present an image of the selected product on the website to allow a consumer to purchase the selected product from an associated retailer, where the image includes a URL link to a product page of the associated retailer.

9. The apparatus of claim 8, wherein the processor is further configured to receive a bid from one or more retailers for the key attribute, select a winning bid from the received bids, and select a product associated with the retailer of the winning bid.

10. The apparatus of claim 8, wherein the processor is further configured to identify key attributes by one or more of extracting text from the content of the web page, removing common words from the text, determining a frequency of words, determining an importance of words, and combing words into keywords.

11. The apparatus of claim 8, wherein the processor is further configured to identify key attributes by extracting information from video on the web page.

12. The apparatus of claim 8, wherein the processor is further configured to:
receive a selection of a plurality of images; and
store the plurality of images in a shopping cart.

13. The apparatus of claim 8, wherein the processor is further configured to transmit the image of the selected product to a mobile application on a wireless device.

14. The apparatus of claim 8, wherein the processor is further configured to share, via a message, the image of the selected product with other individuals.

15. A system for automatically placing products on a web page to recommend to individuals, the system comprising:
a module for identifying key attributes in content from at least one web page;
a module for assigning one or more products to the key attributes;
a module for assigning one or more universal resource locators (URLs) of retailers to the one or more products;
a module for selecting at least one key attribute identified on the web page;
a module for selecting at least one product associated with the key attribute identified on the web page; and
a module for presenting an image of the selected product on the website to allow a consumer to purchase the selected product from an associated retailer, where the image includes a URL link to a product page of the associated retailer.

16. A computer program product, comprising:
a computer-readable medium comprising:
at least one instruction for causing a computer to identify key attributes in content from at least one web page;
at least one instruction for causing the computer to assign one or more products to the key attributes;
at least one instruction for causing the computer to assign one or more universal resource locators (URLs) of retailers to the one or more products;
at least one instruction for causing the computer to select at least one key attribute identified on the web page;
at least one instruction for causing the computer to select at least one product associated with the key attribute identified on the web page; and
at least one instruction for causing the computer to present an image of the selected product on the website to allow a consumer to purchase the selected product from an associated retailer, where the image includes a URL link to a product page of the associated retailer.
